(19) United States
(12) Patent Application Publication
(10) Pub. No.: US 2007/0172067 A1
(43) Pub. Date: Jul. 26, 2007

(54) System for selective data transmission

(75) Inventors: Begonya Otal, Aachen (DE); Jan Kneissler, Aachen (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/589,110

(22) PCT Filed: Feb. 1, 2005
(86) PCT No.: PCT/IB05/50420

§ 371 Date: Aug. 10, 2006

(30) Foreign Application Priority Data
Feb. 12, 2004 (EP) 04100525.7

(51) Int. Cl. H04N 7/167

(52) U.S. Cl. 380/277

(57) ABSTRACT

A system and method for selective data transmission is described. The system includes a sender S and a plurality of receivers (R1-R4). The sender has associated encryption means (24) comprising a plurality of base keys (k1-k4). The receivers (R1-R4) each have associated decryption means (34) each comprising a receiver set of keys, where each receiver set of keys is a subset of the base keys (k1-k4). For secure, selective transmission of data to a first, authorized group of receivers the encryption means are configured to encrypt the data recursively with at least two of said base keys, which are all comprised in the receiver sets of the authorized group of receivers, and where at least one of these keys is not comprised in each receiver set of the non-authorized group of receivers.

The invention relates to a system for selective data transmission, a sender and receiver for use in a corresponding system, a broadcasting system, a method for selective data transmission and a method for operating a system including a sender and a plurality of receivers.

In a data transmission system, data is transmitted from a sender over a channel to at least one out of a plurality of receivers. The physical channel used for data transmission is outside of the scope of the present invention, and can include any known form of data transmission method and any type of media. The issue addressed in the present disclosure is how to transfer data selectively to one ore more receivers, and to exclude other receivers from receiving the data. This selectivity is achieved by an encryption scheme specifically adapted for this task.

Corresponding systems, senders, receivers, and methods are already known. The data sent over the channel is scrambled, and the necessary key information to descramble the data is in advance distributed among the receivers, so that the desired selectivity—which receivers can and which receivers cannot decrypt the message—is achieved. Due to the encryption employed, these systems are well suited for broadcasting applications, where the channel and method of transmission do not limit the number of receivers.

Data transmission from a sender to a plurality of receivers is termed “multicast” or “point-to-multipoint” transmission. Selective multicast transmission is already applied in areas like pay-TV. But even internet communication as well as mobile communication may make use of selective multicast.

One way to achieve a selective multicast system is to distribute in advance a scrambling key—here termed “multicast key”—to the sender and all receivers authorized to receive the data (here termed a “multicast group”). This method, however, is not very flexible with regard to membership changes. If a previously authorized receiver leaves the multicast group, the previously used multicast key (shared secret) needs to be changed, so that further transmissions are no longer readable for the excluded receiver. A new multicast key needs to be transmitted safely and selectively only to the remaining receivers. In some applications, like pay-TV including pay-per-view systems, membership may be highly dynamic. For theses applications the overhead associated with the necessary key changes must be kept small.

A system which could be used for dynamic membership comprises assigning a unique key to each receiver. This allows the sender, who holds all of the individual receiver's keys, a secure unicast (point-to-point) communication with each receiver. It would be possible to use this system for secure multicast by establishing a multicast key, and to distribute the multicast key from the sender to each of the authorized receivers in encrypted form, using each receiver's individual key. Thus, a multicast group can be established, which can securely communicate data encrypted with the multicast key, excluding non-authorized receivers.

The above described system, although placing low receiver-side demands for storage of keys, would however lead to enormous bandwidth requirements for changing the multicast-key, which would, for N receivers, comprise N transmissions of that key. Considering, that, for example in pay-TV applications, the multicast-key would be changed quite often, for example every minute, these bandwidth requirements become unacceptable for large multicast groups.

An example of a system for selective data transmission which addresses the above problem is given in U.S. Pat. No. 6,049,878. The system includes a sender and a number of receivers. At each receiver, multiple keys are accessible. A multicast key (here termed TEK, traffic encryption key) is shared with the sender and all other receivers. Additionally, each receiver holds a plurality of key encryption keys (KEK). The logical structure of the system is that of a binary tree, with the sender being the root and the receivers being the leaves. Each leaf holds the keys arranged in the path from root to leaf.

In case of leave operations, i. e. a receiver is no longer authorized to receive data, every key in the path to the leaving sender is changed in a bottom-up fashion. The multicast key (TEK) is then changed to exclude the leaving receiver. Further traffic is scrambled using the new, changed TEK, which can no longer be read by the leaving receiver.

The system and method disclosed in U.S. Pat. No. 6,049,878 succeed to reduce the bandwidth required in case of leave operations. However, for every leave operation, still the re-keying of a complete path in the logical tree is necessary.

It is thus the object of the present invention to propose a system and a method for selective data transmission, as well as a sender and receiver for use in a corresponding system, as well as a broadcasting system and a method for operation of the above system, which is well suited for communication in a highly dynamic multicast group.

According to the invention, this object is solved by a system according to claim 1, a sender and receiver for such a system according to claims 10 and 11, a broadcasting system according to claim 12, a method for selective data transmission according to claim 13 and a method for operating a system according to claim 15.

A central idea of the invention is to achieve selective data transmission by employing recursive encryption with a number of consecutively used keys. This recursive encryption, which in the present context will also be referred to as “key chaining”, involves encrypting data with a first key to obtain first encrypted data, and to encrypt the first encrypted data further using a second key to obtain second encrypted data, and so on. Obviously, the finally obtained result after recursive encryption with a number of keys can only be read after recursive decryption with the same keys (generally in reverse order, if the order is important). To read correspondingly recursively encrypted data, the complete combination of keys used in the recursive encryption process needs to be available to a receiver. Thus, by distributing different key combinations to different receivers, a desired selectivity (i. e. which receivers can read a message and which cannot) can be achieved by encrypting the message recursively with keys shared by authorized receivers. Unauthorized receivers are excluded by using at least one key in the recursive encryption chain which is not held by the unauthorized receivers.

A basic system and method according to the invention includes a sender and at least two receivers. The sender has encryption means associated therewith, and holds a plurality of base keys. Each receiver has associated decryption means, which each hold a receiver set of keys. The receiver sets are a subset of the base keys, and are preferably pairwise not contained in each other.

For selective data transmission from the sender to the second receiver, the encryption means use at least two of the base keys for recursive encryption. The used base keys are chosen such that they are both (or all, in the case of more than two) contained in the receiver set of the (authorized) second receiver. They are also chosen such that at least one of the keys used is not comprised in the receiver set of the first receiver, which is to be excluded.

A piece of data, which is thus recursively encrypted and sent over the transmission channel may be picked up at both receivers. But while the (authorized) second receiver can recursively decrypt the data, the (unauthorized) first receiver lacks at least one key and can therefore not decrypt the data.

According to a development of the invention, the system and method are used for selective multicast. A multicast group consisting of the above described second and a further third receiver are authorized to receive the data. Accordingly, the keys used in the recursive encryption are chosen such that all of them are contained in the receiver sets of the (authorized) second and third receiver, while at least one of the used keys is not contained in the receiver set of the (unauthorized) first receiver.

It should be noted that the invention is applicable to a wide range of applications. The used channel can be any type of transmission method and/or medium. Also, practically any encryption method which uses a key to encrypt data can be used. This specifically implies the use of both symmetric and asymmetric encryption methods. Symmetric encryption methods use the same key for encryption and decryption, while in asymmetric encryption methods, the “key” is actually a key pair, of which one key part (usually referred to as the “public” key) is used for encryption and the other part (“secret key”) is used for decryption. Both types of methods can be used in a system according to the invention. The system is also not limited to a specific number of receivers. Obviously, the advantages of the system become more apparent in a larger system, i. e. with a higher number of receivers, e. g. more than 20, 50, 100, 1000 or above. As will be described in connection with preferred embodiments below the use of relatively few base keys already allows to address (i. e. assign a different combination to) a very large number of receivers.

In the general case of a plurality of receivers, which each hold a unique receiver set of keys, data is to be transmitted selectively to an authorized group out of the plurality of receivers. To achieve this, the encryption means at the sender encrypt the data recursively with a plurality of keys, i. e. a specific combination of base keys. This specific combination is chosen such that all of the keys used in the combination are held by the receivers of the authorized group. The receivers of this group are consequently able to recursively decrypt the data using exactly this key combination. On the other hand, the key combination is chosen such that for each unauthorized receiver, at least one of the keys out of the combination is not comprised in the corresponding receiver set of that receiver. Thus, each of the unauthorized receivers lacks at least one key to decrypt the data, and consequently none of the unauthorized receivers can read the clear text data.

According to a further development, selective transmission of data to an authorized group of receivers is achieved in multiple transmissions by dividing the authorized group into a plurality of subgroups. This may be necessary in cases where selective transmission to a specifically designated group of authorized receivers is called for, but there is no single key combination available which satisfies the above demands to ensure selective multicast. In these cases, the same data is transmitted multiple times encrypted with a different set of keys, i. e. a different key combination. Each of the different key combinations used satisfies the above given demands, i. e. all keys in the combination are held by the receivers of the corresponding subgroup, and each further receiver, not belonging to that subgroup, lacks at least one key out of the combination.

According to a development of the invention, a specific class of encryption methods is proposed. The preferred class of encryption methods includes, during encryption, calculation of at least one exponentiation with a key number. This class of encryption method relies on the fact that the inverse operation (discrete logarithm problem) is not easily solvable. Recursive encryption with a number of keys, as described above, which would normally comprise recursive exponentiation with the key numbers can thus be calculated as a simple multiplication of key numbers and only one exponentiation with the result of the multiplication. Since exponentiation operations are computationally expensive, and multiplication operations are not, the use of an encryption method out of the preferred class greatly reduces computational effort during recursive encryption. Preferably, the chosen encryption method also allows decryption using a plurality of keys in the same way, i. e. by multiplying key numbers and only one exponentiation operation with the result thereof. An example of a corresponding encryption method is the well known RSA algorithm.

According to a further development of the invention, an issuing scheme is proposed where the whole of receivers is subdivided into a plurality of groups. For each group, a communication scheme as described above is established: For each group, a group set of base keys is available. The receivers which belong to a certain group hold keys which are a subset of the group set of that group. The group sets of different groups are pairwise different, and preferably even pairwise disjoint.

The subdivision of the total of receivers into a plurality of groups makes it possible to address a very large number of receivers, with a relatively small number of keys which need to be stored at each receiver.

While it is generally possible that different receivers hold different numbers of base keys, it is preferred that each receiver holds the same number of base keys, i. e. the receiver sets have the same cardinal number.

As explained above, the system and method according to the invention may be employed for secure, selective multicast to a group of authorized receivers while excluding unauthorized receivers. As further explained, this may be achieved by encrypting the message recursively with a combination of keys, which needs to be carefully chosen. While it is generally preferable to find a single key combination which includes all authorized receivers and excludes all unauthorized receivers, this may not be possible with a given key distribution (issuing scheme) and a specific scenario of authorized/unauthorized receivers (joining vector). In these cases, as explained above, multiple transmissions with a plurality of key combinations may be used for sequentially transferring the message multiple times, each time encrypted with a different combination, such that finally all authorized receivers may receive the message.

To determine the above described one or more combinations according to a development of the invention, the sender has associated storage means with information about authorized and/or unauthorized receivers, and distribution control means for determining one or more combinations of base keys to be used for transmitting a message selectively to the authorized receivers, while excluding unauthorized receivers. It is of course preferred that the distribution control means determine a minimum number of combinations of base keys necessary to achieve the above specified selective transmission.

A further development of the invention relates to the distribution of base key combinations among the receivers (issuing scheme). Consider a number N of receivers, a number k of base keys existing at the sender, and each receiver holds a number m of these base keys. In this scenario, there are k over m different combinations of the available base keys possible, so that a maximum of k over m receivers could be addressed. An issuing scheme, where all or nearly all possible combinations of base keys are indeed distributed to the receivers will be called “exhaustive”, while schemes were only a minimum of the available key combinations is actually in use will be called “in-exhaustive”. Different issuing schemes were evaluated with the regard to their redundance. By redundance it is understood how many transmissions (combinations of base keys) are necessary under specific given circumstances. The applied criteria may be an average redundance taken over a large number of possible joining scenarios (combinations of authorized/unauthorized receivers), or a worst case redundance, which indicates the highest number of necessary transmissions taken over a large number of scenarios.

It has been found that generally a lower redundance (i. e. fewer number of transmissions necessary) was achieved with medium exhaustive issuing schemes, i. e. schemes where k over m is substantially greater than N (preferably at least 10%, or even more than 25%). Instead of actually using all possible combinations, it is thus proposed to use only a limited part of them to achieve better performance. Also, as very in-exhaustive issuing schemes are generally a waste of resources and in some cases even show poor performance, it is generally preferred to use schemes where k over m is bounded by a power of N with a moderate exponent, e. g. k over m<Nˆ10. This would correspond to using a number of base keys which is maximally roughly ten times greater than the required minimum.

According to a further development of the invention, the base keys do not necessarily remain the same throughout the complete operation. Under several circumstances it may at times be desirable to exchange one ore more of the base keys, e. g. out of security reasons. Of course, the new base keys have to be communicated to the receivers, but selectively only to those receivers, which are authorized to hold the exchanged base keys. This is achieved by using, after generation of one or more new base key, the above described system and method for selective data transmission for selectively transmitting the new base key to exactly those receivers which should receive it.

The sender according to the invention may be used in the above described transmission system. The sender holds a plurality of base keys. Encryption means are configured to encrypt data recursively as described above.

In the same way, the receiver according to the invention has decryption means which hold a receiver set of keys and are configured to decrypt encrypted data recursively with a number of these keys.

The invention further relates to a broadcasting system. A broadcasting system comprises the transmission system described above, with a sender and a plurality of receivers. The broadcasting system further comprises a broadcasting sender, which broadcasts scrambled content. The content is scrambled using scrambling means, and a scrambling key. It should be noted, that the term “scrambling” here relates to any sort of encryption, and is preferably a block cipher. The term “scrambling” is used here instead of “encrypting” to distinguish the content scrambling operation from the above described encryption of messages.

The scrambled content is continuously broadcast, so that in principle the number of receivers which receive this broadcast is not limited. However, receivers need the scrambling key to de-scramble the scrambled content. The scrambling key is selectively transmitted to authorized receivers by the transmission system described above. It should be noted, that the broadcasting sender and the sender from the transmission system may be one and the same, but this is not necessary.

The invention further relates to a method for operating a system including a sender and a plurality of receivers. The method comprises the steps of determining an issuing scheme, generating base keys, and distributing base keys to joining receivers. Issuing schemes have been mentioned above. As discussed, different issuing schemes greatly vary in performance because of different redundance. Since the redundance directly corresponds to the bandwidth necessary during operation of the system, a good average/worst case redundance is highly desirable. It is thus recommended to determine, in advance, an issuing scheme given a number of base keys, a (maximum) number of receivers and a number of base keys stored at each of these receivers. The generation of this issuing scheme (i. e. a plan, how base key combinations should be distributed among the receivers) may be computationally quite expensive. But this step is preferably carried out in advance, so that no real time criteria have to be satisfied. Further, the step can be done once and for all, because the issuing scheme is completely independent of the actual base keys, and also of the encryption scheme actually used.

In the following, preferred embodiments of the invention will be described with reference to the drawings, where

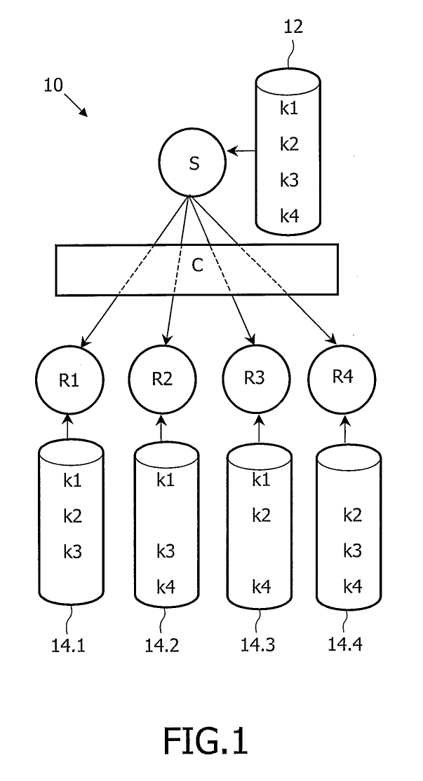

FIG. 1 shows a symbolic representation of an embodiment of a transmission system according to the invention;

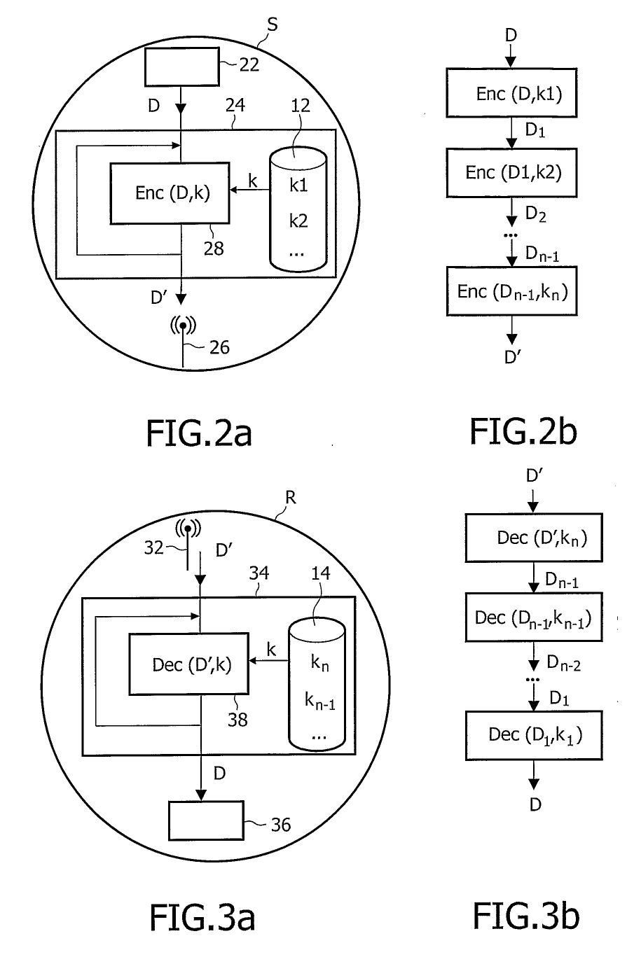

FIG. 2a shows a symbolic representation of a sender of the system shown in FIG. 1, with recursive encryption means;

FIG. 2b illustrates in a symbolic representation steps of recursive encryption;

FIG. 3a shows a symbolic representation of a receiver out of FIG. 1, with a decryption system;

FIG. 3b illustrates in a symbolic representation steps of recursive decryption;

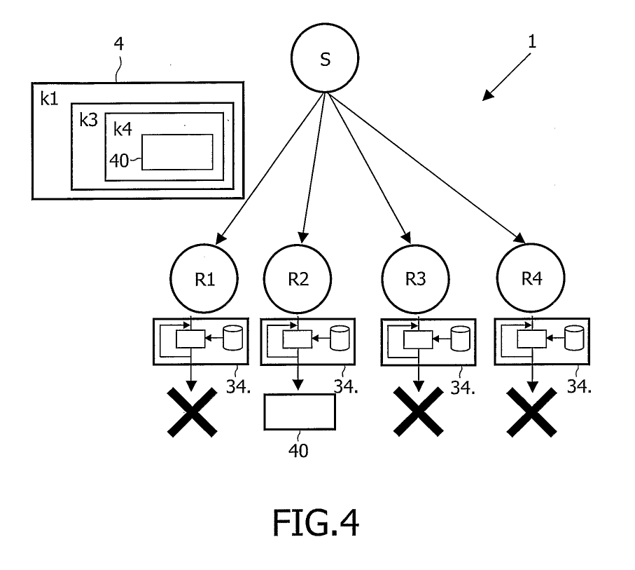

FIG. 4 shows in symbolic representation a first communication example with unicast communication;

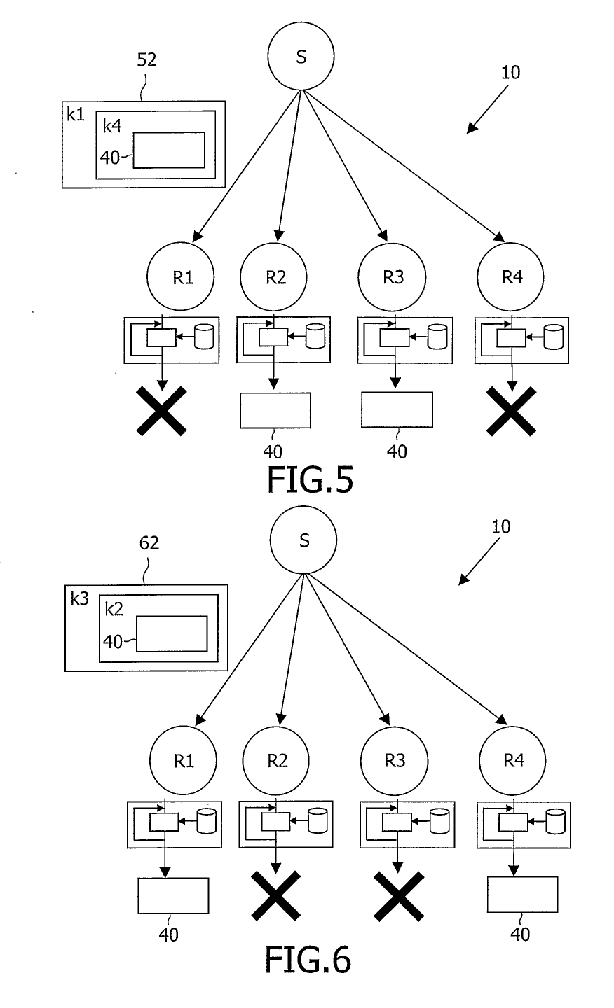

FIG. 5 shows in a symbolic representation a second communication example with multicast communication to a first group of receivers;

FIG. 6 shows in a symbolic representation a third communication example with multicast communication to a second group of receivers;

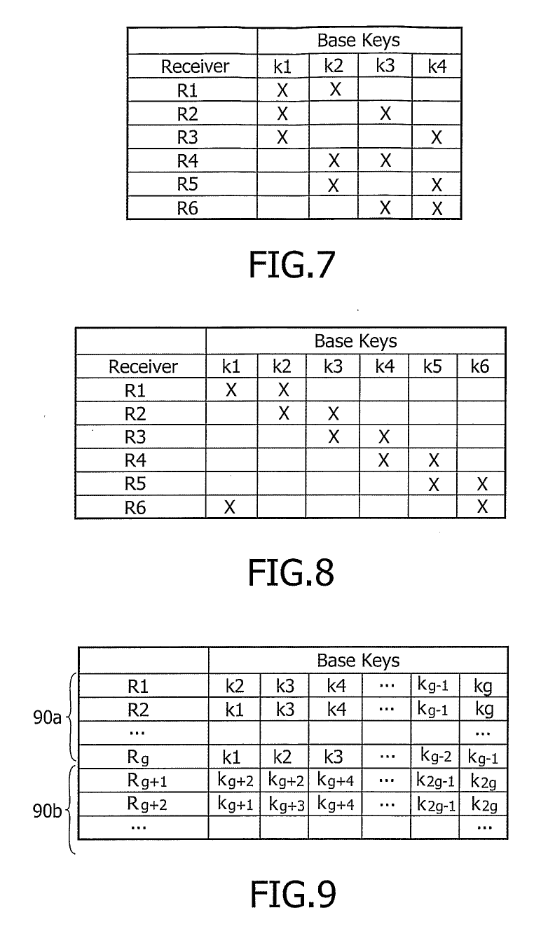

FIG. 7 shows a table with a first issuing scheme;

FIG. 8 shows a table with a second issuing scheme;

FIG. 9 shows a table with a third, grouped issuing scheme;

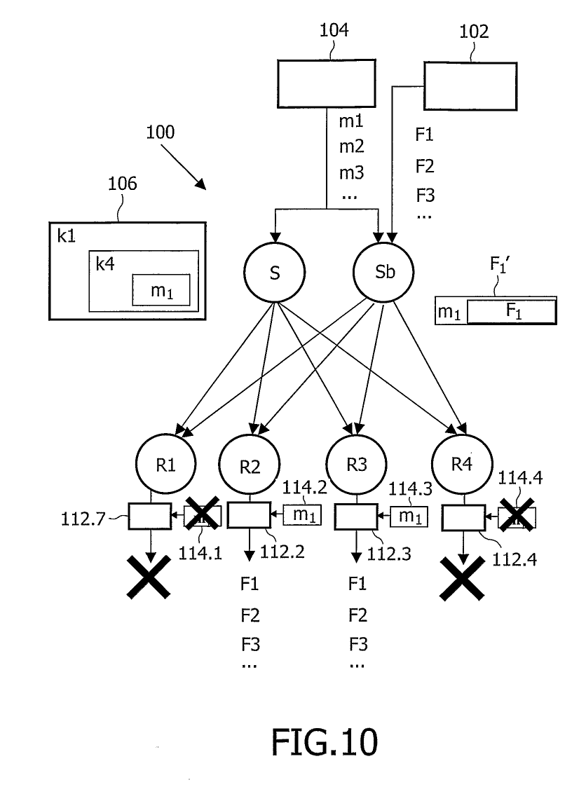

FIG. 10 shows an embodiment of a broadcasting system;

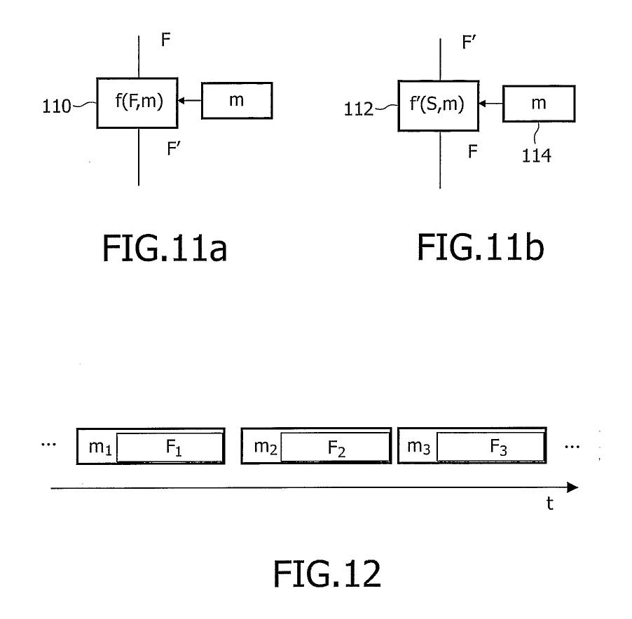

FIG. 11a shows a symbolic representation of a scrambling system;

FIG. 11b shows a symbolic representation of a de-scrambling system and

FIG. 12 shows a sequence of scrambled content pieces.

FIG. 1 shows a basic transmission system 10 according to an embodiment of the invention. The system 10 comprises a sender S and a number of receivers, R1, R2, R3, R4. The sender S is connected to each of the receivers R1, R2, R3, R4 via a channel C. Channel C in the present example allows communication only uni-directional from the sender to the receivers. The channel is of such a nature that data sent from sender S can be received at each of the receivers R1, R2, R3, R4. It should be noted that system 10 is a general example, and that channel C can include any type of media and transmission method, like for example radio broadcast over the air, data transmission in a computer network or others.

Sender S is connected to a database 12 which stores a number of cryptographic keys k1, k2, k3, k4. Each of this keys may be used to encrypt data using an encryption scheme. In the preferred embodiment, the encryption scheme used is the RSA algorithm, and keys k1, k2, k3, k4 are RSA public keys. This encryption scheme will be explained further below. It should be noted, however, that the invention is not limited to this specific encryption scheme, but instead any encryption scheme could be employed.

The keys k1, k2, k3, k4 will further be called the base keys of the system 10. They form a base key set, the cardinal number of which in the example given is 4. It should be noted, however, that in a preferred system according to the invention, there will be a larger number of base keys, and also a far lager number of receivers.

Each of the receivers R1, R2, R3, R4 has a local database 14.1, 14.2, 14.3, 14.4. In each of the databases 14.1, 14.2, 14.3, 14.4, cryptographic keys are stored. Each database 14.1, 14.2, 14.3, 14.4 stores a different combination of base keys, which is here referred to as the receiver set of the associated receiver R1, R2, R3, R4. For example, the receiver set of the first receiver R1 stored in database 14.1 comprises base keys k1, k2, k3, while the receiver set of the second receiver k2 stored in database 14.2 comprises base keys k1, k3, k4.

The different combinations of base keys may also be referred to as establishment keys. In total, there are k base keys available (in the present example, k is equal to 4). There are thus 2^{k}-1 combinations of these base keys available. In the preferred embodiment, however, as in the example of FIG. 1, each of the receiver sets of keys comprises the same number of base keys, i. e. has the same cardinal number m (in the example of FIG. 1, m equals 3).

There are thus different

$$( \begin{matrix}k \\ 20 \\ m\end{matrix} )$$

key combinations available, so that this number of receivers with different receiver key sets may be present. In the example of FIG. 1, all 4 available combinations are distributed to the receivers R1, R2, R3, R4. The choice, how many base keys should be available, how many keys should be stored at each receiver, and which combinations of keys should be used is here called an “issuing scheme”. Issuing schemes will be further discussed below.

As shown in FIG. 2a, the sender S from FIG. 1 comprises a message unit 22, a recursive encryption unit 24 and a sending unit 26. Message unit 22 delivers data D, which is encrypted in encryption unit 24 to encrypted data D′. Encrypted data D′ is delivered to sending unit 26 to be sent over channel C.

Encryption unit 24 includes database 12 with base keys k1, . . . , kₙ, and an encryption module 26. Encryption module 26 takes input data D and a cryptographic key k and encrypts data D with a key k. As stated above, the actual encryption method implemented in encryption module 26 is not limited. There are a large number of encryption methods known. In the preferred embodiment, the RSA algorithm is used. Although the details of the RSA encryption algorithm are well known to the skilled person, the algorithm will be briefly summarized:

The key in the RSA encryption algorithm is actually a key pair, comprising a public key and a private key. The public key corresponds to a number e, which is relatively prime to (p−1)(q−1), where p and q are large prime numbers, which are kept secret. The private key corresponds to a number d, such that d*e mod ((p−1)(q−1))=1. Also public is the base n, which is the product of the large prime numbers p and q. During encryption, a message corresponding to a number x with 0≦x<n is encrypted using only the known base n and the public key e as y:=x^{e} mod n. Decryption, on the other hand necessitates the private key d, and is done by x=y^{d} mod n.

In the example of FIG. 2a, the encryption module 26 encrypts data D with a single RSA encryption step as described above.

However, the total of encryption unit 24 implements a special encryption using a number of keys from database 12, which involves several calls of module 26 and will here be referred to as recursive encryption. FIG. 2b illustrates the course of this encryption. Input data D is first passed through encryption module 26 for a first time, and is encrypted using a first key k1. The obtained encrypted data is then passed through encryption module 26 a further time, and is further encrypted using a second key k2. This recursive procedure is continued until encryption has been effected with all of a desired combination of keys k1, k2 . . . kₙ. The finally obtained encrypted data D′ is the final result of this recursive encryption process.

FIG. 3a shows a generic receiver R, which corresponds to the receivers R1, R2, R3, R4 from FIG. 1. Receiver R includes a receiving unit 32, a decryption unit 34 and a processing unit 36. The broadcast data from the sender is received at receiving unit 32.The received data is decrypted in decryption unit 34 and delivered to processing unit 36 for further processing.

Analogous to the recursive encryption explained with regard to FIG. 2a, 2b, decryption is also effected recursively. A decryption module 38 is employed recursively with a number of keys kₙ, kₙ₋₁, . . . k₁. The course of the recursive decryption is shown symbolically in FIG. 3b, where in each step the decrypted data from the previous step is further decrypted using the next key.

Since generally encryption operations, such as that performed in encryption module 26, may require a large number of computations, recursive encryption with a number of keys could potentially become a computationally complex task. If, however the encryption method used is RSA, and all keys k1, k2 . . . used share the same base n, the recursive encryption process can be simplified. Instead of multiple, recursive exponentiation operations, multiplication of the exponents can be effected:
y=( . . . ((x^{e1})^{e2}) . . . )^{ek} mod n=x^{e1*e2* . . . *ek} mod n

In the same way, recursive decryption can be simplified as:
x=(( . . . (y^{dk}) . . . )^{d2})^{d1} mod n=y^{d1*d2* . . . *dk} mod n

It may be possible, that using multiple RSA keys with the same base n will reduce key security. However, the savings with the regard to calculation are enormous. Thus, for many applications, the tradeoff of lesser security vs. drastically limited computational demands may be acceptable. For example in pay-TV applications, total key security may not be absolutely critical, and low user-side demands for decryption hardware provide a great advantage.

The potential security problem may be reduced, at the expense of increased computational complexity, by not choosing all keys with the same base n, but to have subsets of keys, e. g. with 2-10 keys each, which have the same base, but where the base is different for different groups. Chaining of keys out of the same subset may then be performed by multiplication, but chaining of keys out of different subsets will require multiple exponentiation operations.

FIG. 4 shows a first communication example within system 10. The setup of system 10 is as shown in FIG. 1. The sender has an encryption unit 24 (not shown in FIG. 4) which holds base keys k1, k2, k3, k4. Each of the receivers R1, R2, R3, R4 have a decryption unit 34.1, 34.2, 34.3, 34.4 associated, and a database 14.1, 14.2, 14.3, 14.4 which holds the individual receiver's receiver set of keys.

In the first example, sender S sends data corresponding to a clear text message 40. The message 40, however, is not sent in clear text, but as encrypted data 42. As shown in FIG. 4, the clear text message 40 was recursively encrypted using base keys k4, k3 and k1 in that order.

The encrypted message 42 is sent to all receivers R1, R2, R3, R4. All receivers receive the message, and try to decrypt it. However, only the second receiver R2 has the key combination (base keys k1, k3, k4) necessary to decrypt message 40. All other receivers R1, R3 and R4, lack at least one base key: receiver R1 does not hold the required base key k4, R3 does not hold k3, and R4 does not hold k1.

Thus, in the system 10 it is possible to conduct a unicast communication (from sender S to receiver R2) the clear text of which cannot be received by any other receiver.

FIG. 5 shows a second communication example within system 10. Again, the setup is as given in FIG. 1. Sender S sends message 40 recursively encrypted using base keys k4, k1 as encrypted message 52. The encrypted message 52, which is received at all receivers R1, R2, R3, R4, can only be decrypted by those receivers which holds both base keys k1 and k4, i. e. the second receiver R2 and the third receiver R3. The other receivers each lack one key for decryption: R1 does not hold k4, and R4 does not hold k1. Thus, FIG. 5 shows an example of a secure multicast (from sender S to the group comprising receivers R and R3), which cannot be decrypted by any other receiver.

FIG. 6 shows a third communication example within system 10. The third communication example is complementary to the second communication example shown in FIG. 5. Sender S sends encrypted data 62, which corresponds to message 40 recursively encrypted with keys k2, k3. In the same manner as above, FIG. 6 shows an example of secure multicast from sender S to receivers R1 and R4, exclusively.

Generally, although not shown in FIGS. 4-6, the encrypted message should contain information about which keys are necessary to decrypt it (and in which order, if the order is important).

What has above been demonstrated using the simple example from FIG. 1, with only 4 base keys and only 4 receivers is generally true and can easily be applied to scenarios with a large number of receivers.

In each case, there will be a certain number of receivers authorized to receive a transmission, while the rest of the receivers is not authorized. To represent this, a joining vector is defined which is a list of numbers being either 0 or 1 corresponding to the set of all receivers. The joining vector contains a 1 entry for authorized receivers, and a 0 entry for unauthorized receivers. For the first communication example of FIG. 5, the joining vector would be (0, 1, 1, 0) while in the second example according to FIG. 6 the joining vector would be (1, 0, 0, 1).

As mentioned above, a major issue with regard to the setup of a transmission system is the chosen issuing scheme, i. e. how the different base key combinations are distributed among the receivers.

The main parameters governing the issuing scheme are the maximum number of receivers N, the number of base keys held by each receiver m and the total available number of base keys k.

Principally the number m of base keys available at the receivers may differ. However, in the following, only such issuing schemes will be regarded, where m is the same for all receivers. It can be shown, that the redundance of these issuing schemes is at least equal to, and in most cases better than that of issuing schemes where the number base keys at each receiver differs.

It should be noted, that the value m for practical applications should generally be kept low. Since preferred systems include a large number of receivers, the corresponding decryption means (decryption unit 34) and key storage means (database 14.1, 14.2, 14.3, 14.4) are needed in large numbers, so that it is preferable to be able to use inexpensive hardware. Such inexpensive hardware, however, will not be able to store a large number of keys.

The above given communication examples with regard to FIG. 4, FIG. 5 and FIG. 6 illustrate how secure multicast may be achieved for the different joining vectors. In these examples, the messages were delivered to all authorized receivers (with a 1 entry in the joining vector) in only one transmission. However, this may not always be possible. Depending on the joining vector and the issuing scheme there will be situations where two transmissions are necessary to reach all authorized receivers, i. e. a first transmission to reach a first subgroup of the authorized receivers and a second transmission to reach the remaining authorized receivers. In the same way, three, four or more transmissions may be necessary. In the worst case, the number of transmissions may be equal to the number of receivers. Of course, if a large number of transmissions are necessary, the overall efficiency of the transmission system is reduced.

Therefore, the number of transmissions necessary, which will be termed “redundancy” here, defines the performance of the transmission system. As stated above, this depends on the joining vector and the issuing scheme. Since joining behavior during operation of a transmission system is not known in advance, in most cases may only be described stochastically, and may even be completely random, it is desirable to chose an issuing scheme with a good overall performance. The redundancy of an issuing scheme may, for example, be measured as an average redundancy over a large number, or even all possible 2^{N} joining vectors. Redundancy may also be defined as worst case, i. e. maximum number of necessary transmissions over a large group, or all, joining vectors.

As already mentioned, for evaluation of different issuing schemes, we call an issuing scheme exhaustive if all possible sub-combinations of base keys are indeed assigned to individual receivers. Consequently, an issuing scheme will be call minimally exhaustive, if only a very small part of the possible combinations is used as receiver key sets. A medium exhaustive issuing scheme is in between these two extremes, using more of the possible combinations than a minimally exhaustive, but less than an exhaustive issuing scheme. It has been found, that with regard to issuing scheme performance, medium exhaustive issuing schemes tend to have a lower redundancy.

In FIG. 7 and FIG. 8 are examples given for different issuing schemes with six receivers (N=6). FIG. 7 shows a tetrahedral scheme with k=4 base keys, out of which each receiver set contains m=2.

Thus, the issuing scheme of FIG. 7 is maximally exhaustive

$$( ( \begin{matrix}k \\ n\end{matrix} ) = 6 = ) .$$

The hexagonal issuing scheme of FIG. 8 has k=6 base keys, out of which each receiver set contains m=2. Since here

$$( \begin{matrix}k \\ m\end{matrix} ) = 15$$

the actually used N=6 combinations make the hexagonal issuing scheme of FIG. 8 medium exhaustive (only 40% of all combinations are used).

Now let us consider the above issuing schemes for a joining vector of (1,0,1,1,0,1). Obviously, in both cases it is not possible to transmit a message to all four authorized receivers R1, R3, R4, R6 in only one transmission. Instead, the tetrahedral issuing scheme of FIG. 7 necessitates four transmissions:

| Receivers Reached | Base Key Combination Used |
|---|---|
| R1 | k1, k2 |
| R3 | k1, k4 |
| R4 | k2, k3 |
| R6 | k3, k4 |

Thus, in the given example the joining vector is so unfavorable with regard to the given issuing scheme, that the message needs to be transmitted in four unicast transmissions. However, the same joining vector necessitates only two transmissions in the issuing scheme according to FIG. 8:

| Receivers Reached | Base Key Combination Used |
|---|---|
| R1, R6 | k1 |
| R3, R4 | k4 |

It can be shown, that for the hexagonal scheme of FIG. 8 the worst case redundancy is 3, i. e. a maximum of 3 transmissions is necessary. Thus, in a transmission system with six receivers, the worst-case redundancy can be reduced from 4 to 3 by issuing and storing two additional base keys.

Generally, the following approach can be used to find optimized issuing schemes. The algorithm given below actually evaluates average and/or worst case redundancy of a large number of issuing schemes for all possible joining vectors, to find an optimum or near optimum solution:
1. For all N (number of receivers), e.g. from 10-100:
2. Make a list L_{schemes} of all possible issuing schemes of length N
3. For all issuing schemes in L_{schemes}:
4. Make a list L_{joining} all 2^{N} possible joining vectors
5. For all joining vectors in L_{joining}:
6. Determine redundancy of the present issuing scheme for the present joining vector
7. Determine average and/or worst case redundancy of the present issuing scheme
8. Determine the best issuing schemes out of L_{schemes} with regard to average and/or worst case redundancy

It should be noted that running the above given algorithm for a large range of lengths N will be a computationally very complex task. However, the optimization needs to be run only once in advance to establishing a messaging system. Since no real time requirements need to be fulfilled, there should be enough processing capacity available to perform the above optimization.

A special class of issuing schemes are grouped issuing schemes. The total of receivers is subdivided into receiver groups. For every group, there is a set of base keys available. The base key sets of different groups are pairwise disjoint.

FIG. 9 shows a general example of the grouped issuing scheme, where each group has a size g of receivers, and every receiver has g-1 base keys. For group 90a, which contains receivers R1-R_{g}, base keys k1 to k_{g} are available. For a second group 90b, which contains g receivers R_{g+1}-R_{2g}, there are also g keys k_{g+1} to k_{2g} available.

It should be noted, that in FIG. 9, that the issuing schemes within the individual groups 90a, 90b are identical. Thus, when performing the above given optimization algorithm, a suitable issuing scheme found for a certain number N of receivers may be employed in a grouped issuing scheme for groups of size N. Thus, for communication systems with a large number of receivers, e. g. more than 10,000, the algorithm need not be executed with N=10,000, but the 10,000 users could be subdivided into 100 groups of group size 100, and an optimized issuing scheme determined by the above algorithm for N=100 can be used within each of these groups.

As explained above, it is computationally advantageous to use the RSA algorithm for encryption, and to use keys which share the same base n. In grouped issuing schemes, it is preferred that only the keys within the same group share the same base n, which may reduce potential security problems and simplifies key generation.

After an issuing scheme for an intended maximum number of receivers N (or a corresponding group size) has been determined, and the required number of base keys has been generated, a data transmission system can be set up in the following way: A status list with 3 possible entries, “active”, “inactive”, “unused” per predetermined receiver key set is generated, where initially all values are “unused”. This status list is maintained throughout the whole lifetime of the communication system, giving the information about the corresponding subscriber's state. Also, a list of identifiers for users that left the service is kept (left-list).

Now, the individual receivers join the system. Upon joining of a receiver, it is first determined if the receiver is in the left-list. If this is the case, the receiver is handed out the receiver key set that he previously held. The corresponding status tag is changed from “inactive” to “active”. If the joining receiver is not contained in the left-list, an (e. g. the first) predetermined user key set that has status “unused” is handed out to the user. The corresponding status tag is set to “active”.

If the receiver leaves, the status is changed from “active” to “inactive”. For security reasons, it should be avoided to send a new receiver key set to a re-joining receiver. It cannot be excluded that receivers keep copies of previous key sets, so that after leaving and re-joining several times a receiver could collect a large number of keys, which would allow to decipher almost every transmission, at least for a significant period of time.

If the lifetime of the transmission system is long compared to the average joining time of users, the system operator may find that after time the space of available key sets will be near exhaustion. In this case, it is proposed to exchange one or more base keys. If for all of the receiver key sets which contain the exchanged base keys the corresponding status list shows an “inactive” entry, the key may simply be exchanged at the sender. If, however, a currently “active” user holds one of the base keys which should be exchanged, the newly generated keys can be securely distributed to these users by using the above encryption algorithm, where the new base key is the encrypted message. It should be noted, that unlike the initial sending of user key sets at subscription time, the transmission of exchanged base keys does not require a separate, secure channel.

In the following, there will be some examples given for communication systems with a larger number of receivers.

In a first example, each receiver stores 10 keys. In total, there are 15 base keys available. This leads to approximately 3000 different possible key combinations, out of which only 1000 (33%) are used to address a maximum of 1000 receivers. The individual combinations used (issuing scheme) is determined using the given algorithm for N=1000.

In a second example, the total of receivers is subdivided into groups of a maximum of 200 receivers. The total number of receivers is unlimited. Each receiver holds 8 keys out of a total number of 12 available base keys per group. A medium exhaustive issuing scheme (40% of the possible 495 combinations used) is determined with regard to minimum worst case redundancy.

In a third example, there are in total 30 base keys available, out of which each receiver holds 15. There is thus a key large number of combinations available (more than 155 million), so that even with a medium exhaustive issuing scheme a large number of receivers may be addressed.

In the following, an extension of the above described data transmission system to a broadcasting system will be described.

FIG. 10 shows the general structure of a broadcasting system 100. The broadcasting system 100 has a broadcasting sender Sb. A content source 102 continuously delivers content data F1, F2, F3 . . . to broadcasting sender Sb. Also, a multicast key generator 104 continuously delivers multicast keys m₁, m₂, m₃ . . . to broadcasting sender Sb. Broadcasting sender Sb includes a scrambling unit 110 as shown in FIG. 11a. Scrambling unit 110 scrambles a received content data F to a scrambled content data F′ using a scrambling key (multicast key) m.

Broadcasting sender Sb continuously broadcasts scrambled content data. The delivered content data F1, F2, F3 . . . is continuously scrambled with the delivered multicast key m₁, m₂, m₃ . . . and the resulting scrambled content data F1′, F2′, F3′ . . . is broadcast.

The scrambled broadcast data can be received by an principally unlimited number of receivers. Here again, the broadcasting media or channel will not be further regarded.

The broadcasting system 100 further comprises a sender S, which is identical to the sender S from the communication system according to FIG. 1, and which holds a number of base keys as described in connection with that figure. Sender S also continuously receives the multicast keys m₁, m₂, m₃ . . . from key generating unit 104. Sender S has included or associated therewith storage means with information about authorized and non-authorized receivers. Sender S continuously encrypts the actual multicast keys m₁, m₂, m₃ . . . recursively with a selected combination of base keys and broadcast the thus encrypted key information as an encrypted message 106.

The broadcasting system further includes 4 receivers R1, R2, R3, R4. On one hand, these receivers correspond to those in communication system 10 according to FIG. 1, and include recursive encryption units 24 and key data bases 14. The distribution of base keys among the receivers is the same as given in FIG. 1. On the other hand, the receivers R1, R2, R3, R4 each include a de-scrambling unit 112 and a multicast key storage 114.

FIG. 11b illustrates a de-scrambling unit 112, which processes scrambled content data F′. The data F′ is de-scrambled using a multicast key m retrieved from multicast key storage 114 to reconstruct clear text data F. The scrambling unit 110 in the sender and the de-scrambling unit 112 of the receivers operate inverse to each other. For the scrambling and de-scrambling operation generally any type of encryption method may be used. It is preferred to use a fast block cipher.

Next, the operation of the broadcasting system 100 will be described. Broadcasting system 100 could be, for example, a pay-TV system where TV content is continuously broadcast in scrambled form, and only subscribing users (authorized receivers) should be able to view the content. The system is adapted to be highly dynamic, so that e. g. pay-per-view is possible. Therefore, the scrambling key (multicast key) is changed quite often over time, e. g. every minute.

The actual TV content data F1, F2, F3 . . . delivered from source 102 is continuously encrypted using the multicast keys valid a different points in time. FIG. 12 shows a symbolic representation of the content data continuously scrambled with changing multicast keys m₁, m₂, m₃ . . . .

In parallel to the scrambled broadcasting of broadcasting sender Sb, sender S continuously distributes the multicast keys valid at any given time to the authorized receivers.

In the example of FIG. 10, only receivers R2 and R3 are authorized, while receivers R1 and R4 are not authorized. Key generator 104 generates multicast key m₁ and delivers it to both broadcasting sender Sb and sender S. Sender S encrypts multicast key m₁ with base keys k1, k4 and sends the corresponding encrypted message 106 to all receivers. Due to the chosen combination of base keys, only authorized receivers R2 and R3 can decrypt the message and receive multicast key m₁. Receivers R2 and R3 each store multicast key m₁ in their respective key storage 114.2, 114.3. Receivers R1 and R4 cannot decrypt encrypted message 106, so that their respective key storage 114.1, 114.4 does not contain the valid multicast key m₁.

Broadcasting sender Sb in parallel scrambles current program feature F1 with current multicast key m₁ and broadcasts the scrambled content data F1′ to all receivers. While all of the receivers R1-R4 receive the encrypted data, only authorized receivers R2, R3 have previously obtained the current multicast key m₁, so that they can de-scramble the message F1′ to retrieve the current TV feature F1.

The above described operation is continuously repeated with consecutive features F1, F2, F3 . . . and continuously changing multicast keys m₁, m₂, m₃ . . . . In case of subscriber changes (e. g. receiver R3 does not subscribe to feature F3) the sender S is notified and correspondingly the encryption of the multicast key m₃ is changed. In the given example, sender S would encrypt multicast key m₃ recursively with base keys k1, k3, k4 so that only subscribed receiver R could receive the multicast key m₃ and consequently de-scramble feature F3.

It should be noted, that while in the example of FIG. 10 broadcasting sender Sb and sender S are shown as separate entities, they may in fact be combined. Especially, the encrypted key data 106 and the scrambled content data F1′ may be transmitted in the same way over the same channel, and preferably combined together as a single stream of data.

While the above description shows examples of communication systems, communication within these systems, issuing schemes, communication methods, operating methods, and broadcasting systems and methods, these examples were chosen merely for illustrative purposes and should not be construed as limiting the scope of the present invention. There are a number of modifications and extensions of the above systems and methods possible.

1. System for selective data transmission with
a sender
and at least a first and a second receiver
with encryption means associated with said sender said encryption means comprising a plurality of base keys
a transmission channel from said sender to said receivers for transmission of encrypted data
and with decryption means associated with each of said receivers said decryption means each comprising a receiver set of keys, where each receiver set of keys is a subset of said base keys
where for transmission of data at least to said second receiver said encryption means are configured to encrypt said data recursively with at least two keys, said keys being comprised in said receiver set of said second receiver, and at least one of said keys not being comprised in said receiver set of said first receiver
and were said decryption means of said second receiver are configured to decrypt said data recursively with said at least two keys.

2. System according to claim 1,
said system further comprising a third receiver with decryption means comprising a receiver set of keys which is a subset of said base keys
where said receiver sets of said first, second and third receiver are pairwise different,
and where said receiver set of said second receiver sand said receiver set of said third receiver comprise at least two common keys where at least one of said at least two common keys is not comprised in said receiver set of said first receiver,
and where for transmission of data to a group at least comprising said second receiver and said third receiver said encryption means are configured to encrypt said data recursively with at least said two common keys
and where said decryption means of said second and third receiver are each configured to decrypt said data recursively with at least said two common keys

3. System for selective data transmission according to claim 1 with
a plurality of receivers each with associated decryption means with a receiver set of keys, where said receiver sets are pairwise different,
where an authorized group of said receivers is authorized to receive said data,
and where for transmission of said data to the receivers of said authorized group, said encryption means are configured to encrypt said data recursively with a plurality of keys all of said keys being comprised in said receiver sets of the receivers of said authorized group, and for each receiver not belonging to said authorized group at least one of said keys not being comprised in the corresponding receiver set,
and were said decryption means of the receivers of said authorized group are configured to decrypt said data recursively with said plurality of keys

4. System according to claim 3, where
said authorized group of receivers is divided into at least two subgroups,
and for transmission of said data to the receivers of said authorized group, said data is transmitted to said receivers in at least two transmissions, where in each transmission the data is encrypted recursively with a different set of keys, all of said keys being comprised in said receiver sets of the corresponding subgroup of receivers.

5. System according to claim 1 where
said encryption means are configured for recursive encryption with a plurality of encryption steps, where in each encryption step a piece of data is encrypted with a key to calculate an encrypted piece of data
where each of said encryption steps includes calculation of at least one exponentiation with a key number associated with said key,
said encryption means being configured to recursively apply said encryption steps with a plurality of keys by multiplying key numbers associated with said keys, and calculating an exponentiation with the result of said multiplication.

6. System according to claim 1, with
a plurality of receivers,
where said receivers are divided into a plurality of groups
where for each of said groups the encryption means comprise a group set of base keys, said group sets being pairwise different from each other,
and the decryption means of each of said receivers comprise a receiver set of keys, which is a subset of the group set of the group that the respective receiver is a member of.

7. System according to claim 1, with
a plurality of receivers with decryption means associated with each of said receivers said decryption means each comprising a receiver set of keys, where each receiver set of keys is a subset of said base keys
where each of said receiver sets of keys comprises the same number of base keys.

8. System according to claim 1, with
a plurality of receivers,
and storage means associated with said sender which store information about a first, authorized group of receivers out of said plurality of receivers, and/or about a second, unauthorized group of receivers out of said plurality of receivers,
where said sender comprises distribution control means for controlling message transmission, said distribution control means being configured to determine one or more combinations of said base keys such that messages recursively encrypted with said combinations are decryptable only at said receivers belonging to a first group, and are not decryptable at said receivers belonging to said second group.

9. System according to claim 1, with
a number k of base keys,
and a number N of receivers, and with decryption means associated with each of said receivers, said decryption means each comprising a receiver set of keys, where each receiver set of keys is a subset of said base keys,
where
$$( \begin{matrix}k \\ m\end{matrix} )$$
each receiver set of keys contains a number m of said base keys,
where is substantially greater than N.

10. Sender for use in a transmission system according to claim 1, with
encryption means comprising a plurality of base keys said encryption means being configured to encrypt data recursively with at least two of said base keys
and transmission means for transmitting said encrypted data over a transmission channel

11. Receiver for use in a transmission system according to claim 1, with
receiving means for receiving encrypted data of a transmission channel
and decryption means comprising a receiver set of keys,
where said decryption means are configured to decrypt said encrypted data recursively with at least two of said keys.

12. Broadcasting system with
scrambling means for scrambling content with a scrambling key
a broadcasting sender for broadcasting said scrambled content over a channel,
said broadcasting system further comprising a selective data transmission system according to claim 1 with a sender and receivers for selectively transmitting the scrambling key,
where said receivers each comprise de-scrambling means for de-scrambling said scrambled content with said scrambling key

13. Method for selective data transmission, where encrypted data is transmitted
from a sender comprising a plurality of base keys
to at least a first and a second receiver each comprising a receiver set of keys, where each receiver set of keys is a subset of said base keys
where for selective transmission of data two set second receiver said method includes the following steps:
at said sender encrypting said data recursively with at least two keys said keys being comprised in said receiver set of said second receiver and at least one of said keys not being comprised in said receiver set of said first receiver
transmitting the encrypted data over a transmission channel
and, at said second receiver decrypting said encrypted data recursively with said at least two keys

14. Method according to claim 13, said method further comprising the steps of
determining at least one base key to exchange,
generating at least one new base key,
encrypting the new base key recursively with a plurality of base keys, and transmitting the thus encrypted key to a plurality of receivers.

15. Method for operating a system including a sender and a plurality of receivers said method comprising the steps of
determining an issuing scheme for issuing a number of base keys to a number of receivers where each of said receivers holds a number of said base keys
generating said base keys
and, upon joining of said receivers distributing said base key to said receivers according to said predetermined issuing scheme.
